(19) United States
(12) Patent Application Publication
(10) Pub. No.: US 2026/0150771 A1
(43) Pub. Date: Jun. 4, 2026

(54) WIDE SWEEP WEEDING MACHINE FOR HIGH DENSITY CROPS

(71) Applicants: BONA TERRA, A.C., Aguascalientes, Aguascalientes (MX); CENTROS CULTURALES DE MÉXICO, A. C., Ciudad de México, Ciudad de México (MX)

(72) Inventors: Eduardo DE LA VEGA SEGURA, Aguascalientes (MX); Mario Armando CABOARA ANGULO, Aguascalientes (MX); Juan Pablo Antonio CISNEROS BARBA, Aguascalientes (MX); Alfredo PEDROZA DÍAZ, Aguascalientes (MX); Luis Enrique OROZCO ROBLES, Aguascalientes (MX); Héctor Emilio VILLALOBOS ALTAMIRA, Aguascalientes (MX); Pablo Emiliano ÍÑIGUEZ MÁRQUEZ, Aguascalientes (MX); Edgar Jair MARÍN CALZADA, Jesús María (MX); Miguel Ángel SANTIAGO MARTÍNEZ, Aguascalientes (MX)

(21) Appl. No.: 19/128,766

(22) PCT Filed: Nov. 11, 2023
(86) PCT No.: PCT/IB2023/061403

§ 371 Date: May 9, 2025

(30) Foreign Application Priority Data
Nov. 11, 2022 (MX) MX/A/2022/014272

(51) Int. Cl. A01B 39/19; A01B 39/22

(52) U.S. Cl. CPC A01B 39/19; A01B 39/22

(57) ABSTRACT

The present invention relates to a flexible weeder for sowings of one or more rows with short inter-row spacings of 5 to 7 cm and up to 20 cm for different crops, driven by hydraulic motors and connected to the hydraulic system of the tractor to draw power therefrom. The weeder comprises the following systems: a suspension system, a cutting system with discs, a transmission system, a travel system (first embodiment), which includes a leveling system in a second embodiment, and a main structure. The tip of the cutting discs penetrates enough into the soil to remove and loosen roots within the optimum weeding time. The discs comprise blades that penetrate, cutting the roots of weeds or turning over the soil enough to expose the roots of any unwanted vegetation to the sunlight.

### TECHNICAL FIELD

This invention relates to mechanical weeding with actively propelled rotary tools, i.e., powered by drive means (e.g., hydraulic motors), and in particular to an apparatus for the destruction of unwanted vegetation in crops with short inter-row distances of approximately 5 and 7 cm and up to 20 cm, also known as high-density crops.

### PRIOR ART

The technical problem that is faced in crops with short inter-row distances is weeding. Every crop must be subjected this process, which has to be done within a specific period of time (against the clock); otherwise, the weeds will grow faster than the crop, resulting in the harvest being lost. This process for short inter-row distances is currently done by hand in highly unfavorable conditions due to inclement weather conditions, which makes it a critical activity which, if not done, threatens the success of the crops each season; in addition, it is an activity that no one wants to do, so it is a cause of high employee turnover.

The applicant is not aware of any machines on the market that support the weeding method with the restriction of short inter-row distances ranging from approximately 5 to 7 and up to approximately 20 cm, with a sweep of approximately 1 m in a first preferred embodiment of the invention and of up to approximately 4 m in a second preferred embodiment of the invention, per tractor entry.

In the case of the embodiment that encompasses an approximately 4-m sweep, the challenges faced by having an implement that encompasses said crop length are: the suspension, due to the heavy weight it has to withstand; the transmission of power, since, the more crop is cleared, the friction of the cutting tool against the soil increases: the distribution of the cutting tools in several shafts, preferably two, instead of one, as in the first preferred embodiment, because the weight of the cutting discs would bend a single shaft of a long length such as a 4 m; and the leveling system allowing the cutting depth to be adjusted.

This weeding machine is proposed for short inter-row distances, with two preferred embodiments, which can receive the power for rotating the cutting tool by connecting it to the hydraulic system of a tractor. Included in the proposal are weeding discs whose position can be precisely adapted to the geometries of this kind of crops and make the machine flexible as a result. The design of the cutting discs, which can be seen in FIGS. 11 to 13, is a proprietary innovation because, it being a weeding method, it is necessary to loosen the soil and cut or remove any weeds. These discs have a design that ensures both operations with a single part. In FIG. 14 it can be seen that the tip of the disc penetrates approximately only 2 cm into the soil, enough to turn over the soil and loosen the roots, which have a shallower depth, within the optimum weeding time. The blade parallel to the ground and perpendicular to the tip has a dual purpose: cutting and/or removing weeds. In either case, any unwanted vegetation will be removed by cutting the root, because it will stop growing, or by turning over the soil its roots will be exposed to the sunlight causing the weeds to dry out. In addition, a weeding efficiency similar to that of other equipment available on the market can be achieved but at a cost up to 8 times lower, making it a very affordable piece of equipment for all types of growers.

The known state of the art and the problems therein, problems which are solved with the present invention, are discussed below.

| | | Comparison with |
|---|---|---|
| Ref. No. | Description | present invention |
| RU2704453C1 | A soil-surface treatment | The purpose of the |
| | machine using two batteries of | implement presented is only |
| | discs with bent tines to | to break up the ground and |
| | penetrate the ground as much | turn over the soil, weeding |
| | as possible. | being excluded. This |
| | | implement does not have a |
| | | system for transmitting |
| | | tractor power. It moves by |
| | | being pulled. |
| CN112640604A | This is a rotary implement for | The implement presented |
| | soil treatment that draws | here requires a reducer to |
| | power from the tractor outpost | couple the revolutions of |
| | via a reducer. | tractor power output to those |
| | | of the implement. In the |
| | | invention proposed herein, |
| | | power is drawn from the |
| | | hydraulic system. |
| | | The purpose of this machine |
| | | is to grind up the soil without |
| | | the possibility of weeding. |
| CN108450064A | This is a machine with two | The only purpose of said |
| | batteries of parallel discs | invention is to turn over the |
| | connected to the hydraulic | soil and pull out any weeds, |
| | crane of the tractor for depth | but without controlling |
| | regulation, the purpose of | damage to the crop. It is not |
| | which is to treat the soil by | intended to be used in a crop |
| | crushing it into large clumps in | but to prepare ground for |
| | the first battery of discs and | subsequent sowing. |
| | then grinding it into smaller | |
| | clumps in the second battery. | |

### BRIEF DESCRIPTION OF THE FIGURES

FIG. 1 is a plan view of the weeder in accordance with a first preferred embodiment the present invention.

FIG. 2 is a side view of the weeder in accordance with a first preferred embodiment of the present invention.

FIG. 3 is a plan view of the weeder in accordance with a first preferred embodiment of the invention with the semi-removable cover closed.

FIG. 4 is a side section of FIG. 3.

FIG. 5 is a side view of the cutting system of the weeder in accordance with a first preferred embodiment of the invention.

FIG. 6 is a plan view, a section A-A and a section B-B of the weeder in accordance with a second preferred embodiment the present invention.

FIG. 7 is a side section of the weeder in accordance with a second preferred embodiment the present invention.

FIG. 8 is a plan view of the weeder in accordance with a second preferred embodiment of the invention with the semi-removable cover closed.

FIG. 9 is a side section of section D-D of the weeder in accordance with the present invention.

FIG. 10 is a side view of the cutting system of the weeder in accordance with a second preferred embodiment of the invention.

FIG. 11 is an exploded isometric view of the cutting disc of the weeder in accordance with the present invention.

FIG. 12 is an exploded front view of the cutting disc of the weeder in accordance with the present invention.

FIG. 13 is a side view of the cutting disc of the weeder in accordance with the present invention.

FIG. 14 is a diagram of the cutting path of a disc in the crop.

FIG. 15 is a diagram of the path of and the soil turned over by a disc in the crop.

FIG. 16 is a schematic of the plantation and its geometry of two groups of two rows with a spacing of 14 cm between groups and of 7 cm between the rows of each group.

FIG. 17 is a schematic of the plantation and its geometry showing a configuration of 3 discs and their position with respect to the rows of the crop, with the weeding zone dotted.

FIG. 18 is a schematic of the plantation and its geometry showing a configuration with 4 discs, two at the center, with blades on a side oriented towards the center line, and their position with respect to the rows of the crop, with the weeding zone dotted.

FIG. 19 is a schematic of the plantation and its geometry with an equal 10-cm spacing between crop rows.

FIG. 20 is a schematic of the plantation and its geometry showing a configuration of 5 discs, central discs with blades of only 1.5 cm per side, and their position with respect to the rows of the crop, with the weeding zone dotted.

### DETAILED DESCRIPTION OF THE INVENTION

The following detailed description is exemplary only and is not intended to limit the described embodiments or the application and uses of the described embodiments. As used herein, the word “exemplary” or “illustrative” means “serving as an example, instance, or illustration.” Any implementation described herein as “exemplary” or “illustrative” should not necessarily be construed as preferred or advantageous over other implementations. All of the implementations described below are exemplary implementations provided to enable those skilled in the art to make or use the embodiments of the disclosure and are not intended to limit the scope of the disclosure. In addition, for purposes of the description herein, the terms “end”, “upper/top”, “lower/bottom”, “right”, “left”, “vertical”, “horizontal”, “side”, “longitudinal” and derivatives thereof refer to the invention as oriented in the figures. In addition, there is no intention to be bound by any explicit or implicit theory presented in the technical field above, the background, the brief summary or the following detailed description. It should also be understood that the specific devices and methods illustrated in the accompanying drawings, and described in the following description, are merely exemplary embodiments of the inventive concepts defined in the attached claims.

The illustrations generally show non-limiting aspects of the systems and methods of the present description. The various aspects of the present descriptions of the devices should not be construed in any way as limiting the description. In addition, any modifications, concepts, and applications of aspects of the description are to be construed by those skilled in the art as comprised by, but not limited to, the illustrations and descriptions herein. Several modifications, equivalents, variants and alternatives, however, will be readily apparent to those skilled in the art. Any and all such modifications, variants, equivalents and alternatives are intended to fall within the spirit and scope of the present description.

As used herein, the singular articles “a”, “an”, and “the” include plural referents unless expressly and unambiguously limited to one referent. It is also to be understood that the specific devices and methods illustrated in the accompanying drawings and described in the following description are non-limiting representations of several aspects of the description. Therefore, the specific dimensions and other physical characteristics related to the aspects described herein are not intended to be and should not be considered as limiting.

Unless otherwise indicated, all ranges or ratios described herein are meant to encompass any and all sub-ranges or sub-ratios incorporated herein. For example, an established range or ratio of “1 to 10” should be considered to include any and all sub-ranges between (and including) the minimum value of 1 and the maximum value of 10; that is, all sub-ranges or sub-ratios that start with a minimum value of 10 or less, such as, but not limited to, 1 to 6.1, 3.5 to 7.8, and 5.5 to 10. Unless otherwise indicated, all numbers expressing dimensions, quantities of ingredients, flow rates, pressures, etc., used in the description and claims, are to be construed as modified in all instances by the term “approximately”. For the purposes of the present description, the term “approximately” determines a range of ±10%, whereby if a value of “approximately 30%” is specified, the value is within a range of 27% to 33%.

The term “a plurality” used throughout this description refers to an undefined number of elements.

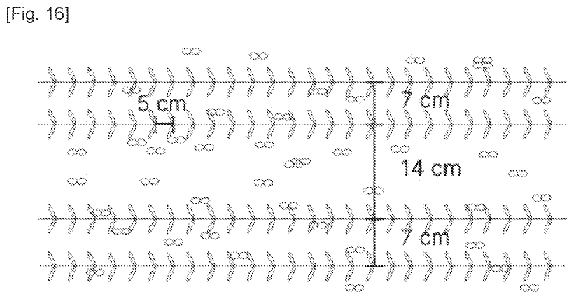

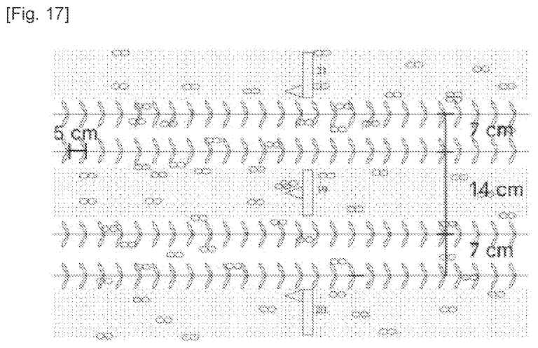

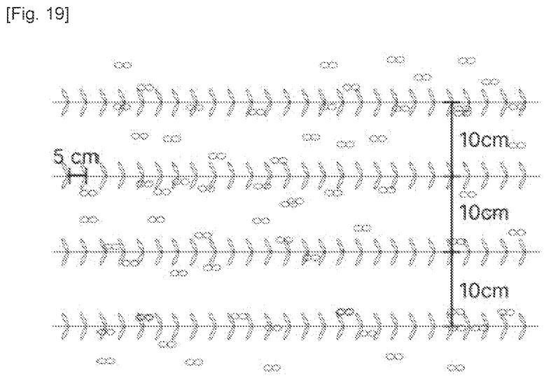

The invention is a flexible weeder for clearing crops sown in one or more rows with short inter-row spacings, from approximately 5 to 7 cm and up to approximately 20 cm, for crops including, but not exclusively, spinach, carrots, garlic, onions, scallions, etc., driven by a pair of hydraulic motors connected to the hydraulic system of the tractor for them to draw their power from. Crops with short distances between planting rows are usually particularly problematic for automated weeding because of the required precision to remove the unwanted vegetation without damaging the crop. Crops with these characteristics are usually sown in consecutive lines of seeds with a more or less regular spacing, known as rows. Rows are spaced from each other according to the preferences of each grower. They may be grouped, as can be seen in FIG. 16, to optimize irrigation use, or evenly spaced, as can be seen in FIG. 19, to optimize soil use. The challenges of this type of distances can be better appreciated in FIGS. 17, 18 and 19, which show examples of plantations posing a challenge for traditional mechanical weeding due to the short distances between sowing rows and the manner in which this invention solves the problem. The clearing area of the machine is four times in parallel that which can be seen in the diagrams shown in FIGS. 17, 18 and 19. In the case of conventional machinery, which normally works at more than 20 cm between rows, it is almost impossible to limit major damage to the crop while removing unwanted vegetation or weeds due to the need for wide distances of more than 20 cm for its tools. The level of soil moisture is an important additional factor in deciding the size of the cutting tools given that the soil breaks up into larger clumps the less moisture it has. Thus, it is necessary to adjust the cutting tools according to the moisture in order to optimize the weeding while minimizing crop damage.

It should be noted that it is essential to replicate the sowing path while cutting. This is achieved with great precision using, e.g, GPS-guided tractors.

The flexible weeder of the present invention is made up of a plurality of systems: a suspension system (1), a cutting system (2), a transmission system (3), a travel system (4), and a main structure (5). In the second preferred embodiment of the invention, the travel system (4) also comprises a leveling system for adjusting the cutting depth.

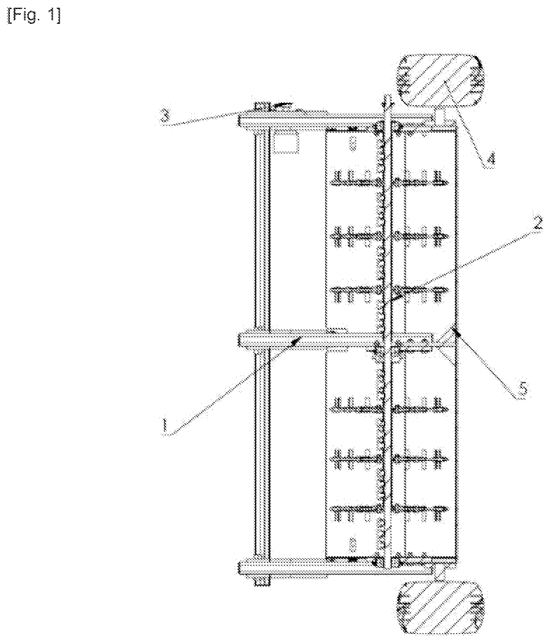

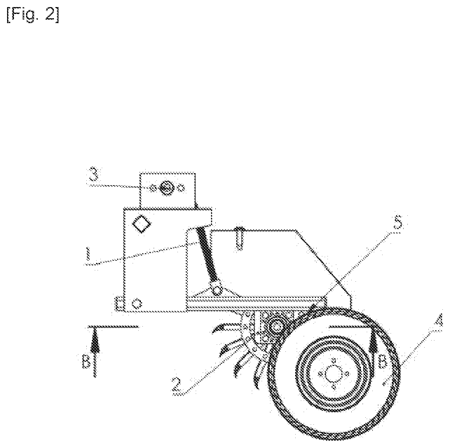

The suspension (see FIGS. 1 and 2 for the first preferred embodiment and 8 and 9 for the second preferred embodiment) is made up of a plurality of parallel subsystems (6), each with a spring (7) through which an axle (10) attached to an arm (12) of the main structure (5) by a bolt (8) at its lower end and a setscrew (9) at its upper end allowing a bracket (11) to compress the spring passes, enabling the weeder to adapt to the irregularities and absorb the forces caused by the variations of the terrain. At the top, the axle (10) passes through a hole in the bracket (11), formed by plates, allowing the passage of the axle (10) and the locking of the spring (7). The arm (12) is hinged between the bracket plates by a bolt. The plurality of subsystems is connected by the cultivator (13), which goes through the plates of the brackets. On the other hand, the arms of the plurality of subsystems of the suspension are attached to the main structure (5).

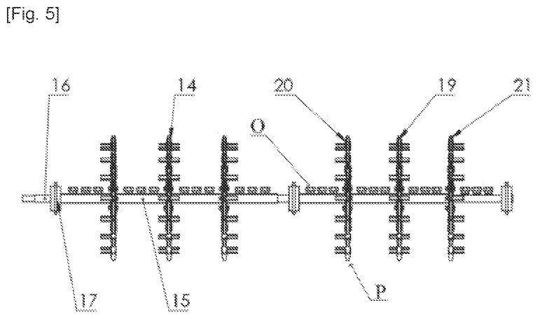

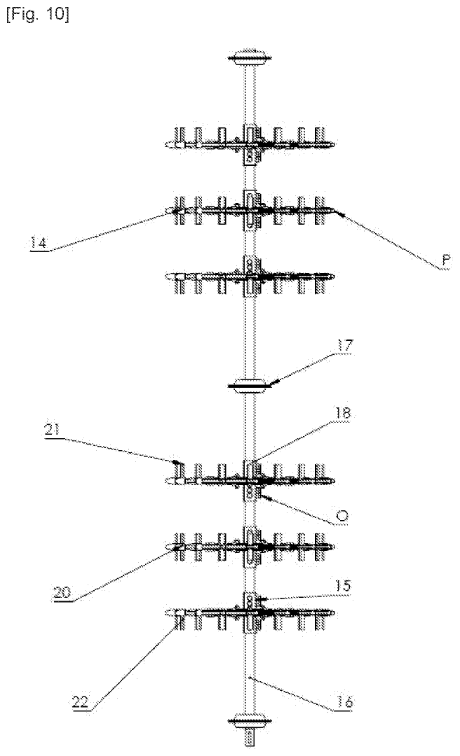

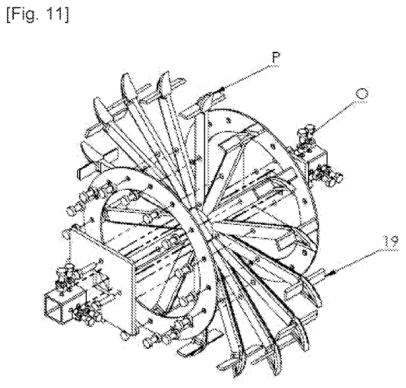

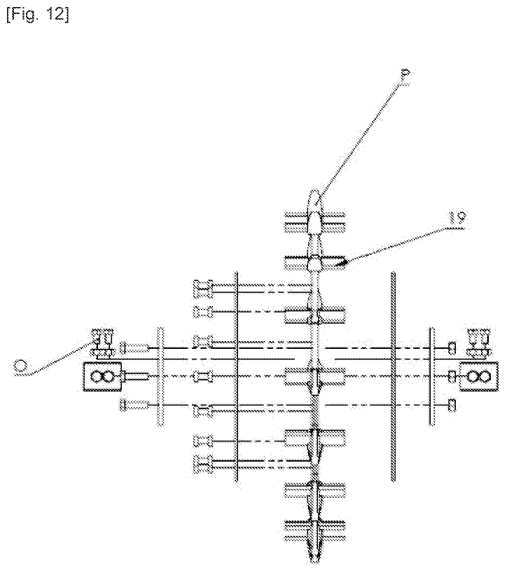

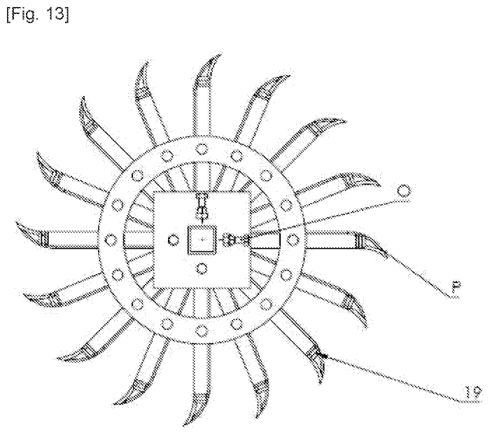

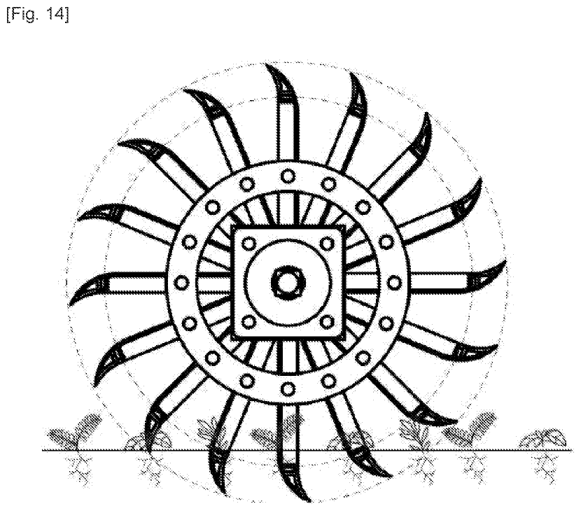

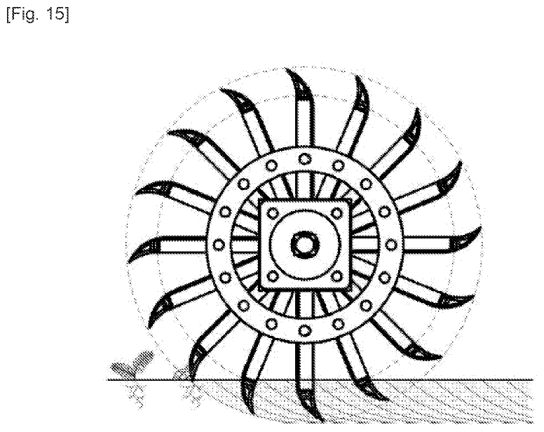

The cutting mechanism in the first preferred embodiment (see FIG. 5) comprises a plurality of cutting discs (14) and a plurality of alternating spacers (15) that couple on a power transmission shaft (16) to a bearing (17) at the beginning, to another one at the midpoint of the shaft and to another one at the end. In the second preferred embodiment (see FIG. 10), said cutting mechanism is made up of two symmetrical, two-meter subsystems with an individual power transmission each. Each of the subsystems is made up of a variable number of cutting discs (14) coupled on power transmission shafts (16) that also comprise a bearing (17) at the beginning, another one at the midpoint of the shaft (16) and another one at the end point of each one. In both cases, the bearings of the cutting mechanism are attached/coupled to the structure (5) of the weeder. The number of discs in the cutting mechanisms, as well as their position, is variable according to the needs of each crop. The position of the discs on the shaft (16) is defined using the spacers (15), which have different lengths and setscrews (O) on one of their sides, preferably arranged parallel to the shaft (16) and which are screwed to fix their position in the first preferred embodiment and fastened by means of a fixing system (18) comprising setscrews in the second preferred embodiment. The fixing system (18) is made up of a rectangular profile centered on and perpendicular to the disc and uses two setscrews on perpendicular faces to fix the disc in place, as can be seen in FIG. 10. Detailing the cutting discs (see FIGS. 11 to 13), it can be seen that the tip (P) of the disc penetrates approximately 2 cm into the soil, enough to turn up the soil and loosen the roots, since the latter have a shallower depth, within the optimum weeding time, as can be seen in FIGS. 14 and 15. In the illustrated embodiments, the blade (19) is parallel to the ground, with a length of approximately 3 cm per side and perpendicular to the tip (P), and has a dual purpose: cutting and/or removing weeds. In either case, any unwanted vegetation will be removed upon cutting the root, because it will stop growing, and by turning over the soil, its roots will be exposed to the sunlight, which will dry them out. A more detailed cutting diagram can be seen in FIG. 15. In the illustrated embodiments there are three types of discs (14): one with blades on both sides (20), and another two with blades only on the left side (21) or right side (22), as can be seen in FIGS. 5 and 10. The discs (14) with blades (9) on both sides are used on the center of the bedding, whereas those with cutting blades on just one side are used for that same side of the bedding.

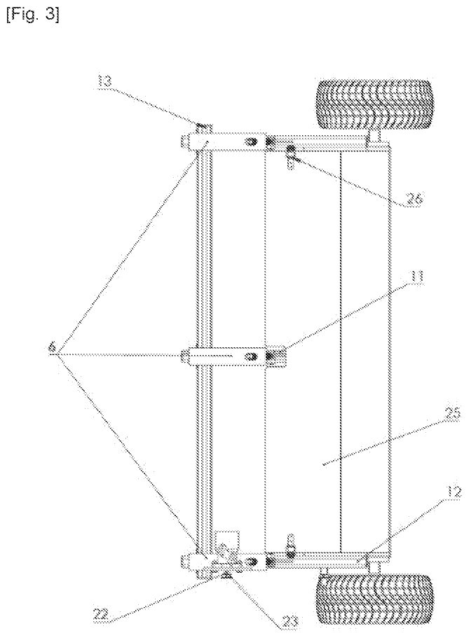

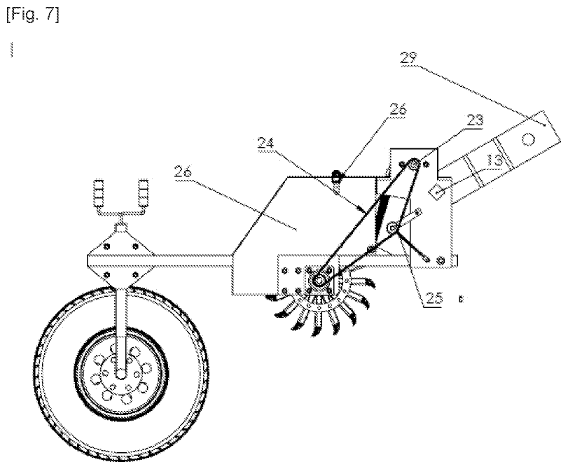

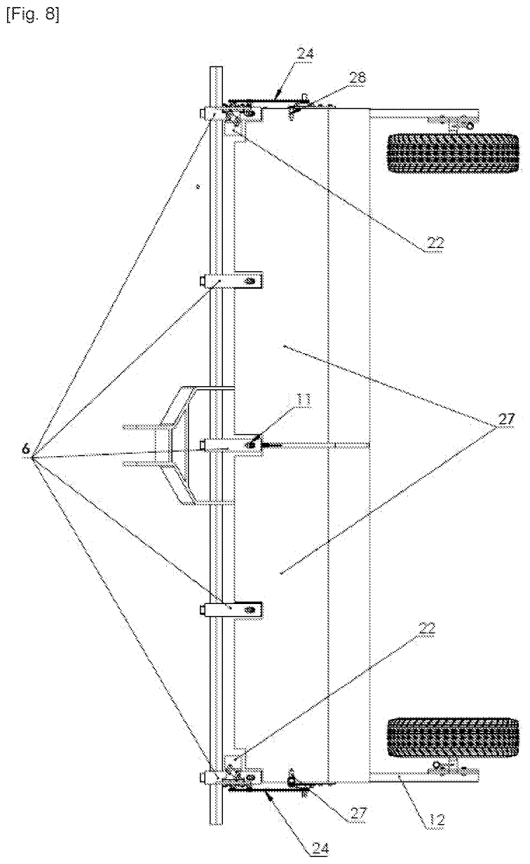

The power of the weeder (see FIGS. 3 and 8) is provided by drive means. Such drive means comprise in the first preferred embodiment at least one hydraulic motor connected to the hydraulic system of the tractor. An axle (22) of the motor and that of the cutting mechanism are connected by a sprocket and chain system (23). In the second preferred embodiment, each of the motors has an axle (23) of the motor connected to the cutting mechanism by a sprocket and chain system (24) tightened by a sprocket and spring mechanism (25) (see FIG. 7) that allows the inertia of the cutting mechanism to be absorbed upon the motor being shut down, protecting the transmission. In both embodiments, the power required by each subsystem is low given that the weeder only turns over the top layer in order to be able to weed.

In the first preferred embodiment, the travel system preferably comprises two rims connected to the structure (5) by an axle and its respective support, which allow the weeder to roll over the crop pulled by the tractor.

In the second preferred embodiment, the travel and leveling system (4) is composed of a plurality of adjustable subsystems, preferably two: one at each end of the machine. Each of the subsystems is preferably composed of a screw mechanism with a crank at one end and an axle with a rim at the other end. The movement of the crank allows the distance between the rim and the crank to be adjusted, thus regulating the cutting depth of the implement. The rims at the end of each of the leveling subsystems allow the machine to be pulled by a tractor. The rims act as shock absorbers, preventing stresses on the structure due to the irregularities of the crop fields.

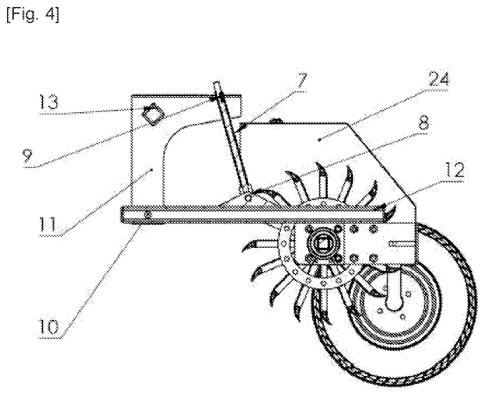

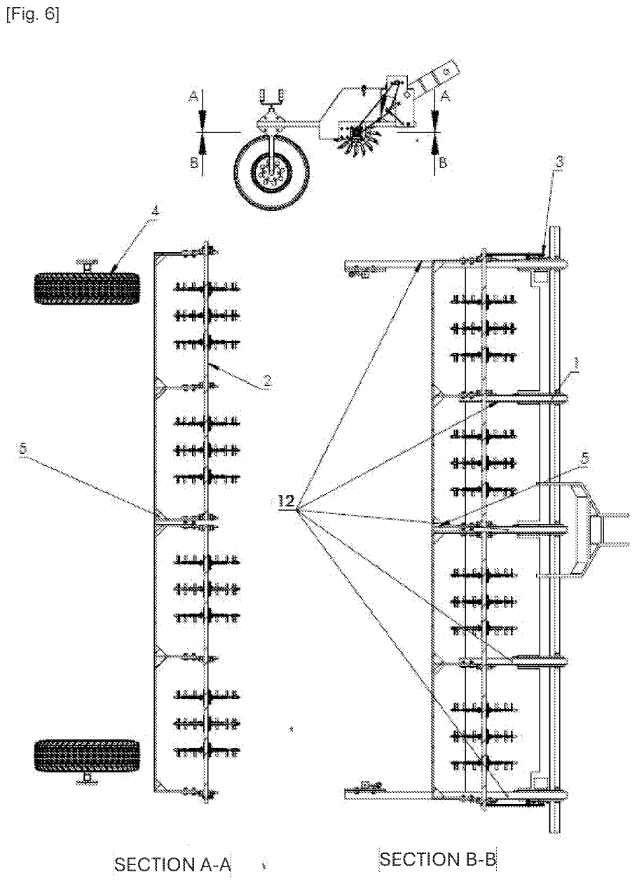

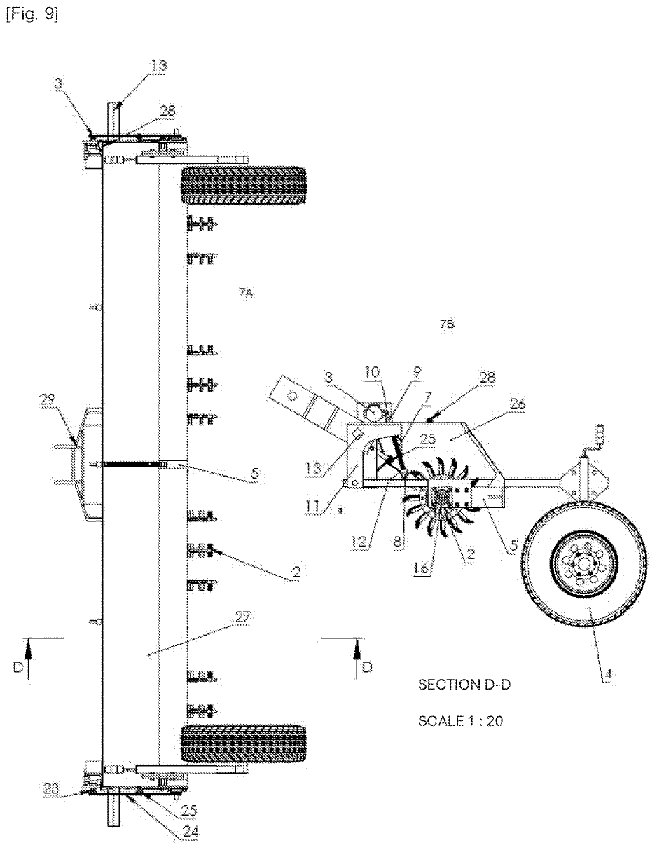

The machine structure (5) is made up in the illustrated embodiments by a 12.7 mm (½″) plate belt to which a plurality of structural arms, where the suspension system is arranged, are coupled, as can be seen in FIGS. 1 and 6. As a safety measure, the weeder is covered on the sides (see FIGS. 3, 4, 8 and 9) and on top, blocking clumps of soil and bits of vegetation that are jetted out by the cutting mechanism. Each side is covered by a cover (26), preferably made of sheet metal, whose lower portion couples to the structure. At the top, the weeder is covered by a partially removable cover (27) attached to the structure by its lower portion and rests atop the side covers when closed. The cover is attached to the side plates with toggle clamps (28). The partially removable cover (27) permits quick access to the cutting system for reconfiguration and maintenance tasks.

A diagram of the plantation and its geometry of two groups of two rows with a spacing of approximately 14 cm between groups and approximately 7 cm between the rows of each group can be seen in FIG. 16, whereas a diagram of the plantation and its geometry can be seen in FIG. 17, which shows a preferred configuration of 3 discs and their position with respect to the crop rows, with the weeding zone dotted, as an example of a configuration of the cutting mechanism.

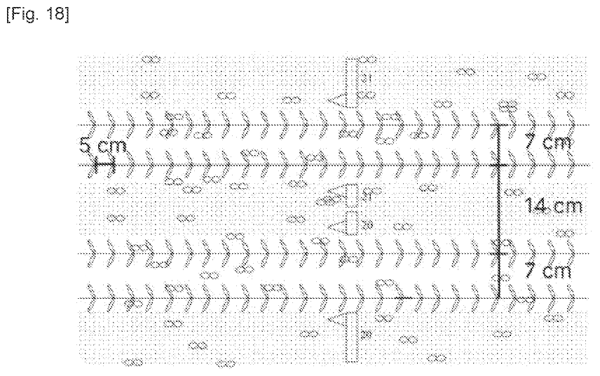

On the other hand, FIG. 18 illustrates a schematic of the plantation and its geometry showing a preferred configuration with 4 discs, two at the center, with blades on one side oriented towards the centerline, and their position with respect to the crop rows, with the weeding zone dotted.

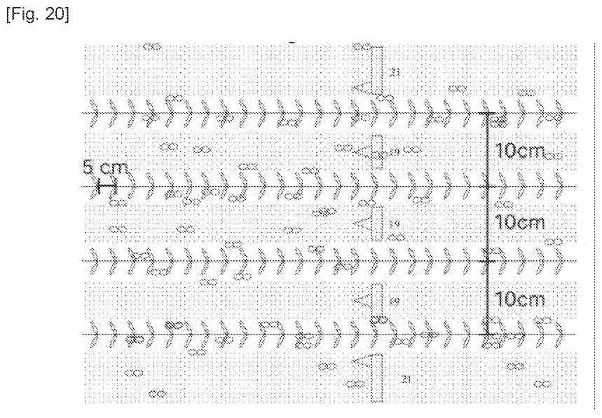

Likewise, FIG. 19 shows a diagram of the plantation and its geometry with an equal spacing of approximately 10 cm between crop rows, and the schematic of the plantation and its geometry can be seen in FIG. 20, which shows a preferred configuration of 5 discs, central discs with blades of approximately 1.5 cm per side, and the position of the discs with respect to the crop rows, with the weeding zone dotted.

The weeding method over inter-row distances of between approximately 5 to 7 cm and up to approximately 20 cm of a group used in both preferred embodiments of the invention.

1) Preparing the cutting system according to the type of crop and its planting or sowing geometry, the necessary number of discs with blades of the appropriate length being installed.

2) Centering and connecting the weeder; in the first preferred embodiment, the hydraulic motor of the weeder is connected to the output of the hydraulic system of the tractor, whereas in the second preferred embodiment, this is achieved by means of the coupling bell (29). Connecting the hoses of the implement to the hydraulic system of the tractor. The connection to the tractor is carried out in the preferred embodiments by means of at least one flow control valve, which is used to vary the power of the drive means and the rotational speed of the discs depending on the moisture of the soil. In the second preferred embodiment, the rotational speeds of each of the cutting subsystems are independent. Soil moisture has to be taken into account when regulating the flow to the motors since the greater the moisture, the slower the flow needed.

It should be clarified that steps 2 to 4 are preparatory, necessary and quick to execute; with experience, they should not take more than 15 minutes.

3) Aligning the tractor and the machine in the crop, where the tractor driver has to align the tractor with the same sowing point of entry. Using a tractor guided by, e.g., GPS, to more accurately follow the sowing path is recommended, and it should be noted that the results of the weeder are optimized when the tractor follows the same path. To align the cutting discs, it is important to fix one of them with regard to the crop as a reference for thus aligning the other discs correctly.

4) Starting the flow of the hydraulic pump of the tractor and leveling the weeder by starting up the hydraulic pump of the tractor and rotating the discs. Subsequently, placing the hydraulic crane of the tractor in place, taking care that the discs have, in the first preferred embodiment, a penetration of approximately 2 cm. In the second preferred embodiment, adjusting the subsystems of the leveling system so that the cutting discs have a penetration of approximately 2 cm into the soil. The components of the leveling system can be adjusted to different heights in order to make up for any inclinations of or irregularities in the terrain.

5) Weeding following the sowing path, where the tractor advances through the crop causing the weeder to roll, the cutting mechanism being moved by the hydraulic pump. The tip (P) of the disc penetrates approximately 2 cm into the soil, enough to turn over the soil and loosen the roots, since they have a shallower depth, within the optimum weeding time. The blade, which in the preferred embodiments is arranged parallel to the ground and perpendicular to the tip, penetrates, cutting the roots of the weeds or turning over the soil enough to expose the roots of any unwanted vegetation to the sunlight. Said configuration, wherein the blade is parallel to the soil and perpendicular to the disc, i.e., parallel to the soil at the lowest point, allows the cutting action to be maximized by minimizing the amount of soil cast in the direction of rotation of the disc. In the illustrated preferred embodiments of the present invention, which is not limited only thereto, the discs feature a plurality of tips, preferably 16, ensuring constant penetration and cutting along the entire furrow. The direction of rotation of the discs is preferably the same as that of the wheels of the tractor. The revolutions at which the discs rotate, which can be adjusted by means of the flow control valve of the motor, are higher than the travel of the tractor to prevent the discs from being dragged without cutting the soil.

Changes to the structure described herein may be anticipated by a person skilled in the art. However, it should be noted that this description relates to preferred embodiments of the invention, and is provided for illustrative purposes only, and should not be understood as limiting the invention. All obvious modifications in the spirit of the invention, such as changes in the shape, material, and dimensions of the elements that make up the invention, should be considered within the scope of the attached claims.

The invention has been described in an illustrative manner, and it should be understood that the terminology used herein is intended to correspond to the nature of the words of the description rather than to provide a limitation.

Obviously, many modifications and variations of the present invention are possible in light of the above teachings. Therefore, it should be understood that within the scope of the invention described, the invention may be practiced otherwise than as specifically described.

1. A flexible agricultural weeder for short distances between crop rows, which comprises:
a main structure;
a travel system with a main rotation axle coupled to a tractor and to the main structure;
a cutting system comprising a plurality of cutting discs which are coupled on one rotation shaft arranged on the main rotation axle of the travel system;
a transmission system arranged on the main structure to transmit the power of the tractor to drive means driving the cutting system; and
a suspension system arranged on the main structure.

2. A flexible agricultural weeder for short distances between crop rows, which comprises:
a main structure;
a suspension system arranged on the main structure,
a travel and leveling system with a main rotation axle coupled to a tractor and to the main structure;
a cutting system comprising a plurality of cutting discs which are coupled on at least two rotation shafts arranged on the main rotation axle of the travel and leveling system; and
a transmission system arranged on the main structure to transmit the power of the tractor to drive means driving the cutting system.

3. The weeder in accordance with claim 1, wherein the cutting system comprises spacers coupled on the power transmission shaft with a bearing at the beginning, another one at the midpoint of the shaft and another one at the end, and wherein the drive means driving the cutting system comprise a hydraulic motor.

4. The weeder in accordance with claim 3, wherein spacers have different lengths and setscrews (O) on one of their sides, preferably arranged parallel to the shaft, and wherein the spacers allow the position of the discs on the rotating shaft to be defined.

5. The weeder in accordance with claim 2, wherein the suspension system comprises a plurality of subsystems, each comprising a spring through which an axle attached to an arm connected to the main structure by a bolt at its lower end and by a setscrew at its upper end passes, a bracket made up of plates that compresses the spring so that the weeder adapts to the irregularities of the terrain, and a cultivator to connect the subsystems to each other.

6. The weeder in accordance with claim 2, wherein the travel and leveling system is composed of two subsystems, each comprising a screw mechanism with a crank at one end and an axle with a rim at the other end for adjusting the distance between the rim and the crank, allowing the cutting depth to be regulated, and wherein the weeder comprises covers on the top and sides for blocking clumps of soil and bits of vegetation that are jetted out by the cutting system.

7. The weeder in accordance with claim 1, wherein each disc of the plurality of discs of the cutting system comprises a plurality of tips (P) and a plurality of blades preferably arranged parallel to the ground and perpendicular to the plurality of tips (P) of the discs for cutting or removing weeds, and wherein the weeder allows weeding crops with distances between approximately 5 to 7 cm and up to approximately 20 cm.

8. The weeder in accordance with claim 1, wherein the number of discs in the cutting system as well as their position are variable according to the needs of each crop.

9. The weeder in accordance with claim 1, wherein the transmission system comprises a sprocket and chain system for rotating the rotation shafts of the cutting system thanks to the drive means and wherein the drive means comprise at least two hydraulic motors.

10. The weeder in accordance with claim 9, wherein the transmission system further comprises a sprocket and spring system for tightening the sprocket and chain system and absorbing the inertia of the cutting system upon the motor being shut down, and wherein the weeder comprises a coupling bell for it to be connected to the tractor.

11. The weeder in accordance with claim 2, further comprising bearings arranged on the rotation shafts, wherein said bearings are coupled to the main structure of the weeder, and wherein the rotation shafts have independent speeds for adjusting to the moisture characteristics of the soil.

12. The weeder in accordance with claim 2, which comprises a fixing system for defining the position of the discs on the rotation shafts, wherein the fixing system comprises setscrews (O) arranged perpendicular to the discs and parallel to the rotation shafts that are coupled to fix the position of the discs.

13. The weeder in accordance with claim 1, wherein the weeder preferably comprises three different types of cutting discs to adapt it to different sowing geometries: one with blades on both sides, one with blades only on the left side, and one with blades only on the right side.

14. The weeder in accordance with claim 9, wherein the at least two hydraulic motors are independently connected to the hydraulic system of the tractor to transmit power to the weeder, wherein each motor comprises an axle that is connected to the rotation shafts of the cutting system by means of the sprocket and chain system.

15. A method of weeding over short inter-row distances using the weeder of claim 1, comprising the steps:
preparing the cutting system according to the type of crop and its planting or sowing geometry, the necessary number of discs with blades of the appropriate length being installed;
centering the machine and connecting it to a tractor;
aligning the tractor and the weeder in the crop, wherein the tractor is aligned with the sowing and the cutting discs are aligned by first fixing one with respect to the crop as a reference and then aligning the other discs;
starting the flow of the hydraulic pump of the tractor to rotate the cutting discs and leveling them to the desired height according to the inclinations of or irregularities in the terrain; and
weeding following the sowing path, wherein the tractor advances through the crop by making the weeder roll with the cutting system driven by the hydraulic pump,
wherein the plurality of tips (P) of each disc penetrate enough into the soil to turn over the soil and loosen the roots, and wherein the plurality of blades penetrate, cutting the roots of the weeds or turning over the soil to expose the roots of any unwanted vegetation to the sunlight.

16. The method of weeding in accordance with claim 15, wherein the connection of the weeder to the tractor is done by means of flow regulating valves to vary the power of the hydraulic motors and the rotational speed of the discs independently depending on the moisture of the soil.

17. The method of weeding in accordance with claim 15, wherein the results of the weeder are optimized when the tractor travels the same path as the sowing path.

18. The weeder in accordance with claim 2, wherein each disc of the plurality of discs of the cutting system comprises a plurality of tips (P) and a plurality of blades preferably arranged parallel to the ground and perpendicular to the plurality of tips (P) of the discs for cutting or removing weeds, and wherein the weeder allows weeding crops with distances between approximately 5 to 7 cm and up to approximately 20 cm.

19. The weeder in accordance with claim 2, wherein the number of discs in the cutting system as well as their position are variable according to the needs of each crop.

20. The weeder in accordance with claim 2, wherein the weeder preferably comprises three different types of cutting discs to adapt it to different sowing geometries: one with blades on both sides, one with blades only on the left side, and one with blades only on the right side.
